(19) United States
(12) Patent Application Publication
(10) Pub. No.: US 2024/0276247 A1
(43) Pub. Date: Aug. 15, 2024

(54) MODEL DATA MANAGEMENT METHOD, MODEL DATA MANAGEMENT APPARATUS, AND STORAGE MEDIUM

(71) Applicants: Beijing Xiaomi Mobile Software Co., Ltd., Beijing (CN); BEIJING UNIVERSITY OF POSTS AND TELECOMMUNICATIONS, Beijing (CN)

(72) Inventors: Qin MU, Beijing (CN); Wei HONG, Beijing (CN); Zhongyuan ZHAO, Beijing (CN); Kailei XU, Beijing (CN); Kexin XIONG, Beijing (CN)

(73) Assignees: Beijing Xiaomi Mobile Software Co., Ltd., Beijing (CN); BEIJING UNIVERSITY OF POSTS AND TELECOMMUNICATIONS, Beijing (CN)

(21) Appl. No.: 18/569,187

(22) PCT Filed: Jun. 13, 2021
(86) PCT No.: PCT/CN21/99489

§ 371 Date: Dec. 11, 2023

(51) Int. Cl. H04W 24/02; H04W 24/06; H04W 36/08

(52) U.S. Cl. CPC H04W 24/02; H04W 24/06; H04W 36/08

(57) ABSTRACT

The present disclosure relates to a model data management method, a model data management apparatus, and a storage medium. The model data management method is applied to a radio access network device, and the method includes: determining a model task completion state of a terminal in response to the terminal handing over a radio access network device; and according to the model task completion state, determining a first radio access network device which transmits model data. The present disclosure can solve the problem of a wireless network AI being unable to perform model training or a training result being unable to be effectively delivered in a high-speed mobile scenario of the terminal.

### CROSS-REFERENCE TO RELATED APPLICATION

The application is a U.S. national phase of International Application No. PCT/CN2021/099489 filed on Jun. 10, 2021, the entire disclosure of which is incorporated herein by reference for all purposes.

### TECHNICAL FIELD

The present disclosure relates to the technical field of wireless communication, and in particular, to a model data management method, a model data management apparatus and a storage medium.

### BACKGROUND

Artificial intelligence such as machine learning or deep learning requires a large amount of data for model training and inference, so as to obtain a high-precision network model and provide accurate decision-making recommendations for terminals. The process is that after the Operation Administration and Maintenance (OAM) obtains the training model, it sends the training model to the radio access network device, and the radio access network device performs model inference and then sends the model inference result to the terminal, and the terminal performs the decision-making task according to the received model inference result.

### SUMMARY

The present disclosure provides a model data management method, a model data management apparatus and a storage medium.

According to the first aspect of the embodiments of the present disclosure, there is provided a model data management method, which is applied to a radio access network device, and the method includes:

in response to a terminal handing over a radio access network device, determining a model task completion status of the terminal; and determining a first radio access network device for transmitting model data according to the model task completion status.

According to the second aspect of the embodiments of the present disclosure, there is provided a model data management method, which is applied to an OAM entity, and the method includes:

in response to a terminal handing over a radio access network device, receiving model data transmitted by a first radio access network device, where the first radio access network device is determined based on a model task completion status of the terminal; and training a model of the terminal based on the data model.

According to a third aspect of the embodiments of the present disclosure, there is provided a model data management apparatus, including:

a processor; a memory for storing instructions executable by the processor; where the processor is configured to: execute the model data management method described in the first aspect or any one of the examples in the first aspect, or execute the model data management method described in the second aspect or any one of the examples in the second aspect.

According to a fourth aspect of the embodiments of the present disclosure, there is provided a non-transitory computer-readable storage medium. When instructions in the storage medium are executed by a processor of a mobile terminal, the mobile terminal is enabled to execute the model data management method described in the first aspect or any one of the examples in the first aspect, or the mobile terminal is enabled to execute the model data management method described in the second aspect or any one of the examples in the second aspect.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram of a system structure of a model data management method according to an embodiment.

FIG. 2 is a flowchart of model training and model inference of a model data management method according to an embodiment.

FIG. 3 is a schematic diagram of a protocol and interface of a mobility management method of a model data management method according to an embodiment.

FIG. 4 is a flowchart showing a model data management method according to an embodiment.

FIG. 5 is a flowchart showing another model data management method according to an embodiment.

FIG. 6 is a flowchart showing another model data management method according to an embodiment.

FIG. 7 is a schematic diagram of a protocol and interface of a terminal handing over under the same gNB-CU when a training task is not completed in the model data management method according to an embodiment.

FIG. 8 is a flowchart showing another model data management method according to an embodiment.

FIG. 9 is a flowchart showing another model data management method according to an embodiment.

FIG. 10 is a schematic diagram of a protocol and interface of a terminal handing over under the same gNB-CU when an inference task is not completed in the model data management method according to an embodiment.

FIG. 11 is a flowchart of AI task delivery when a terminal hands over under the same gNB-CU in the model data management method according to an embodiment.

FIG. 12 is a flowchart showing another model data management method according to an embodiment.

FIG. 13 is a flowchart showing another model data management method according to an embodiment.

FIG. 14 is a schematic diagram of a protocol and interface of a terminal handing over across gNB-CUs when a training task is not completed in the model data management method according to an embodiment.

FIG. 15 is a flowchart showing another model data management method according to an embodiment.

FIG. 16 is a flowchart showing another model data management method according to an embodiment.

FIG. 17 is a schematic diagram of a protocol and interface of a terminal handing over across gNB-CUs when an inference task is not completed in the model data management method according to an embodiment.

FIG. 18 is a flowchart of AI task delivery when a terminal hands over across gNB-CUs in the model data management method according to an embodiment.

FIG. 19 is a flowchart showing another model data management method according to an embodiment.

FIG. 20 is a flowchart showing another model data management method according to an embodiment.

FIG. 21 is a flowchart showing another model data management method according to an embodiment.

FIG. 22 is a flowchart showing another model data management method according to an embodiment.

FIG. 23 is a block diagram of a model data managing apparatus according to an embodiment.

FIG. 24 is a block diagram of another model data management apparatus according to an embodiment.

FIG. 25 is a block diagram of an apparatus for model data management according to an embodiment.

FIG. 26 is a block diagram showing another apparatus for model data management according to an embodiment.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the embodiments of the present disclosure. Instead, they are merely examples of apparatuses and methods consistent with aspects related to the embodiments of the present disclosure as recited in the appended claims.

Artificial intelligence such as machine learning or deep learning requires a large amount of data for model training and inference, so as to obtain a high-precision network model and provide accurate decision-making recommendations for terminals. Terminals or new-generation wireless networks can achieve huge performance improvements by relying on the decision-making recommendations of the artificial intelligence. In order to realize the artificial intelligence wireless network enabled by big data and acquire a model that can improve the performance of the wireless network, it is necessary to determine the wireless network AI framework, the AI module function, and the output-output relationship of each network element.

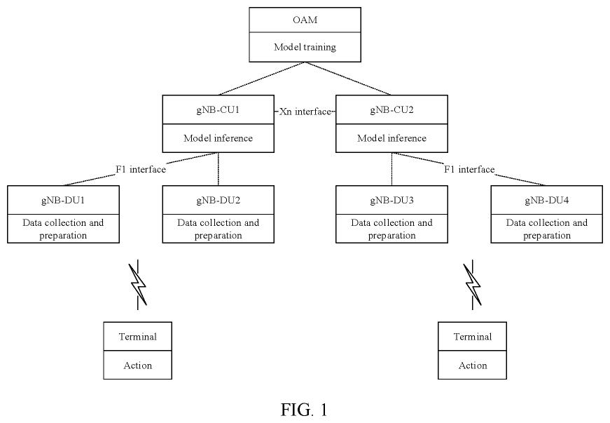

In the 3rd Generation Partnership Project (3GPP) wireless access network (RAN) #88 meeting, the research project for the intelligent optimization of the RAN side was passed: New Radio (NR) and random access (EUTRA-NR Dual Connectivity, ENDC) data collection enhancement study. The RAN3#110e meeting began to discuss its design guidelines, basic concepts, applicable cases, and standard impacts. Among them, a basic functional framework was agreed as the initial architecture. FIG. 1 is a schematic diagram of a system structure of a model data management method according to an embodiment. As shown in FIG. 1, according to the discussion, the potential wireless network architecture supporting artificial intelligence includes the following functional units:

(1) Data collection & preparation: including data collection and data preprocessing functions, where the data collection can be performed in a plurality of network elements, and the provided data includes measurement data, feedback performance data and model performance data, etc.

(2) Model Training: iterating the machine learning model through calculation and processing to obtain a better model for inference, where the input includes training data and model performance feedback, etc.

(3) Model inference: generating a prediction result or a decision-making result by using the trained artificial intelligence (machine learning/deep learning) model.

(4) Execution (Action): formulating and executing a strategy by using the model inference result, and feeding back relevant performance result after the action to Data collection.

The schematic diagram of the system architecture shown in FIG. 1 provides a basis for the realization of wireless artificial intelligence. In the scenario where the terminal has high-speed mobility, in order to ensure the continuity of model training and model inference, and to ensure the continuity of the AI analysis service obtained by the terminal, it is considered to carry out mobility management on the wireless artificial intelligence, and at the same time, to further standardize and optimize the interaction between individual network elements having AI function, so that the wireless network artificial intelligence has stronger and more efficient performance.

In related arts, if the terminal hands over to access the radio access network device before obtaining the inference result, the terminal may lose the result of this inference and re-initiate the analysis subscription request, and the OAM and other related network element(s) may perform a new model training and inference. For example, the terminal initiates an analysis subscription request to the 5G base station distributed unit (next Generation Node B Distributed Unit, gNB-DU), and the gNB-DU sends the analysis subscription request of the terminal to the 5G base station control unit (next Generation Node B Control Unit, gNB-CU), the gNB-CU reports the analysis subscription request of the terminal to the OAM. According to the analysis subscription request of the terminal, the OAM selects the appropriate model to be trained and requests training supplementary data. After acquiring the training data, the OAM starts the model training work. After acquiring the training model, the OAM sends the training model to the gNB-CU, and the gNB-CU requests the model inference data and starts the model inference. The gNB-CU sends the acquired model inference result to the gNB-DU, and the gNB-DU sends the model inference result to the terminal. If the terminal hands over during the above training or inference phase, the inference result cannot be delivered along with the service data at the time of handing over in the conventional mobility management due to the time delay of model training or inference, therefore the terminal may be unable to receive the final model inference result. At this time, the terminal may re-initiate the analysis subscription request, and each network element may re-perform the entire process of model training and inference.

Therefore, in related arts, there are the following technical problems.

(1) When the terminal hands over during the training or inference phase, the terminal may lose the previous model inference result, and the resource overhead generated by the first model training and model inference may be wasted.

(2) When the terminal hands over during the training or inference phase, the terminal may re-initiate the analysis subscription request, and each network element may continue to complete the first model training and inference process, and carry out model training and inference with respect to the analysis subscription request newly initiated by the terminal. These two training and inference require real-time data transmission, and in the case of limited wireless communication resources, this solution will increase the network load.

(3) When the terminal hands over during the training or inference phase, the terminal cannot obtain the model inference result requested by the source base station, and re-initiates the analysis subscription request, and each network element performs model training and inference again. In the whole process, the total delay for the terminal to obtain the inference result includes the delay generated from the initial initiation of the analysis subscription request to the handover of the terminal, and the delay generated by re-executing model training and inference. The delays generated by these two parts are relatively large, which may cause that the inference result feedback is not timely, thereby affecting the terminal service experience.

(4) When the terminal hands over frequently, the OAM may need to perform a plurality of model trainings for the analysis subscription requests of the same terminal, which may lead to insufficient OAM computing power and reduce the system working efficiency.

Based on this, the present disclosure provides a model data management method, so that the wireless network architecture supporting AI has higher stability and efficiency in the mobile terminal scenario, and further provides better AI analysis services for the mobile terminal. The embodiment of the present disclosure provides a method that can ensure the continuity of wireless network AI model training in the high-speed mobile scenario of the terminal, solves the problem that the wireless network AI cannot perform model training or the training result cannot be effectively delivered in the high-speed mobile scenario of the terminal, solves the problem of loss of the inference result caused by the handover of the terminal, ensures the efficiency and stability of the wireless network AI services, improves the terminal service experience, and is also conducive to improving the operating efficiency of the wireless network.

It can be further understood that the wireless communication system in the embodiments of the present disclosure is a network that provides a wireless communication function. The wireless communication system can adopt different communication technologies, such as a code division multiple access (CDMA), a wideband code division multiple access (WCDMA), a time division multiple access (TDMA), a frequency division multiple access (FDMA), an orthogonal frequency-division multiple access (OFDMA), a single Carrier FDMA (SC-FDMA), a Carrier Sense Multiple Access with Collision Avoidance. According to the capacity, speed, delay and other factors of different networks, the network can be divided into the second generation (2G) network, 3G network, 4G network or future evolution network, such as 5G network, and 5G network can also be called a New Radio (NR). For convenience of description, the present disclosure sometimes simply refers to the wireless communication network as a network.

Further, the network device involved in the present disclosure may also be referred to as a radio access network device. The radio access network device may be: a base station, an evolved base station (evolved node B, base station), a home base station, an access point (AP) in a wireless fidelity (WIFI) system, a wireless relay node, a wireless backhaul node, a transmission point (TP) or a transmission and reception point (TRP), etc., or may also be gNB in the NR system, or may also be a component or a part of device that constitutes the base station, etc. When it is a vehicle-to-everything (V2X) communication system, the network device may also be a vehicle-mounted device. It should be understood that in the embodiments of the present disclosure, no limitation is imposed on the specific technology and specific device form adopted by the network device.

Further, the terminal involved in the present disclosure may also be referred to as a terminal device, a User Equipment (UE), a Mobile Station (MS), a Mobile Terminal (MT), etc. The terminal is a device providing voice and/or data connectivity to a user, for example, the terminal may be a handheld device, a vehicle-mounted device with a wireless connection function, and the like. At present, examples of some terminals are: a smart phone (Mobile Phone), a pocket computer (Pocket Personal Computer, PPC), a palmtop computer, a Personal Digital Assistant (PDA), a notebook computer, a tablet computer, a wearable device, or a vehicle-mounted device, etc. In addition, when it is a vehicle-to-everything (V2X) communication system, the terminal device may also be a vehicle-mounted device. It should be understood that the embodiments of the present disclosure do not limit the specific technology and specific device form adopted by the terminal.

According to the present disclosure, there is provided a mobility management method oriented to wireless artificial intelligence, the method including the following steps.

The terminal initiates an analysis subscription request, and the gNB-CU generates model subscription request information based on its own AI processing capability and the analysis subscription request information and sending it to the OAM. According to the model subscription request, the OAM initiates a training supplementary data subscription request to the gNB-CU, and relevant network element(s) collects and processes data and uploads the data to the OAM. The OAM performs model training by using local training data and the training supplementary data to obtain a model that meets the model subscription request, and sends the training model to the gNB-CU. The gNB-CU initiates a model inference data subscription request, and relevant network element(s) collects and processes data and uploads it to the gNB-CU. The gNB-CU performs model inference by using the model inference data, and sends the inference result to the terminal. The terminal makes a corresponding strategy adjustment based on the inference result, and uploads terminal performance feedback data to the gNB-CU. The gNB-CU collects and processes the model performance data and the terminal performance feedback data and reports them to the OAM. The OAM performs training optimization on the model, and sends the updated model to the gNB-CU.

In the scenario where the terminal has high-speed mobility, the work of wireless network model training and inference task can be divided into the following two scenarios.

1) When the terminal hands over to a new gNB-DU under the same gNB-CU, the terminal re-initiates an analysis subscription request, and the gNB-CU updates the analysis subscription request information of the terminal, and determines the completion situation of the current task.

If the current training task is not completed, the gNB-CU resends the model subscription request to the OAM, and the OAM updates the analysis subscription request based on the information reported by the gNB-CU. The OAM re-initiates the training supplementary data subscription request, and the relevant network element(s) collects and processes the data and uploads it to the OAM. The OAM continues the model training by using the local training data and the training supplementary data to obtain a model that meets the model subscription request, and sends it to the gNB-CU. After the handover of the terminal is completed, the gNB-DU newly accessed by the terminal is responsible for relevant data collection and data forwarding tasks.

If the current inference task is not completed, the gNB-CU sends analysis subscription update request information to the OAM, and the OAM updates the analysis subscription request. The gNB-CU continues to complete the inference task. After obtaining the inference result, it sends the inference result to the gNB-DU currently accessed by the terminal according to the access location in the updated analysis subscription request message. This gNB-DU sends the inference result to the terminal, and the terminal performs a corresponding strategy adjustment according to the inference result. After the handover of the terminal is completed, the newly accessed gNB-DU is responsible for relevant data collection and data forwarding tasks.

2) When the terminal hands over to a new gNB-CU, the terminal resends an analysis subscription request, and the gNB-CU newly accessed by the terminal sends a model subscription request to the OAM. The OAM updates the analysis subscription request of the terminal, and sends the updated analysis subscription request information to the source gNB-CU of the terminal. After the source gNB-CU updates the analysis subscription request message, it determines the completion situation of the current task.

If the current training task is not completed, the source gNB-CU will no longer send the training supplementary data to the OAM. The OAM initiates a training supplementary data subscription request to the gNB-CU newly accessed by the terminal, and relevant network element(s) collects and processes data and uploads it to the OAM. The OAM continues the model training by using the local training data and the training supplementary data to obtain a model that meets the model subscription request, and sends it to the gNB-CU newly accessed by the terminal. After the handover of the terminal is completed, the gNB-DU newly accessed by the terminal and the gNB-CU newly accessed by the terminal are responsible for relevant data collection, forwarding, model inference, data feedback and other tasks.

If the current inference task is not completed, the source gNB-CU continues to complete the inference task, and after obtaining the inference result, it sends the inference result to the gNB-CU newly accessed by the terminal according to the access location in the updated analysis request information, and the source gNB-CU is no longer responsible for tasks related to the analysis request of this terminal. The gNB-CU newly accessed by the terminal sends the inference result to the gNB-DU newly accessed by the terminal, and this gNB-DU sends the inference result to the terminal, and the terminal makes a corresponding strategy adjustment according to the inference result. After the handover of the terminal is completed, the gNB-DU newly accessed by the terminal and the gNB-CU newly accessed by the terminal are responsible for tasks such as relevant data collection, forwarding, and model inference.

Alternatively, in some embodiments of the present disclosure, the OAM is responsible for the entire process of data collection, model training, and model inference, and the intermediate network element(s) is only responsible for the task of forwarding data and model inference result. The specific process of the alternative scheme is as follows: the terminal initiates an analysis subscription request, the gNB-DU and the gNB-CU are responsible for forwarding the analysis subscription request to the OAM, the OAM collects local data and then performs model training. After acquiring the model, it requests model inference data and performs model inference, and then sends the inference result to the terminal. When handover of the terminal occurs, the network elements at individual levels only need to report the analysis subscription update request, and the OAM requests the model inference data or sends the inference result according to the location information in the updated analysis subscription request. After receiving the inference result, the terminal makes a corresponding decision-making adjustment based on the inference result.

The technical solutions provided by the embodiments of the present disclosure may include the following beneficial effects: by determining the radio access network device for transmitting data by determining the model task completion status of the terminal, the wireless network architecture supporting AI can have relatively high stability and efficiency in the mobile terminal scenario, the mobile terminal is further provided with better AI analysis services, a method to ensure the continuity of wireless network AI model training in the high-speed mobile scenario of the terminal is provided, the problem that the wireless network AI cannot perform model training or the training result cannot be effectively delivered in the high-speed mobile scenario of the terminal is solved, the problem of loss of the inference result caused by the handover of the terminal is solved, the efficiency and stability of the wireless network AI services is ensured, and the terminal service experience is improved, thereby avoiding the interruption of the AI analysis service required by the user during the handover, ensuring the continuity and efficiency of the AI analysis service for the mobile users, and being also conducive to improving the operating efficiency of the wireless network.

In the embodiments of the present disclosure, the model data management method provided by the present disclosure is executed based on the system structure in FIG. 1. As shown in FIG. 1, the system includes a terminal, gNB-DU, gNB-CU and OAM, the terminal accesses the gNB-DU through a wireless channel, a plurality of gNB-DUs access the gNB-CU through the F1 interface, and the gNB-CUs are connected through the Xn interface. The OAM is mainly responsible for undertaking the work of the model training functional unit in the wireless network architecture supporting AI. The gNB-CU undertakes the work of the model inference functional unit and is responsible for completing the model inference. The gNB-DU mainly undertakes the work of the data collection functional unit, and is responsible for the collection of real-time inference data, the collection of terminal performance feedback data and other work. The terminal undertakes the work of the action execution functional unit, and is responsible for making a corresponding strategy adjustment based on the model inference result.

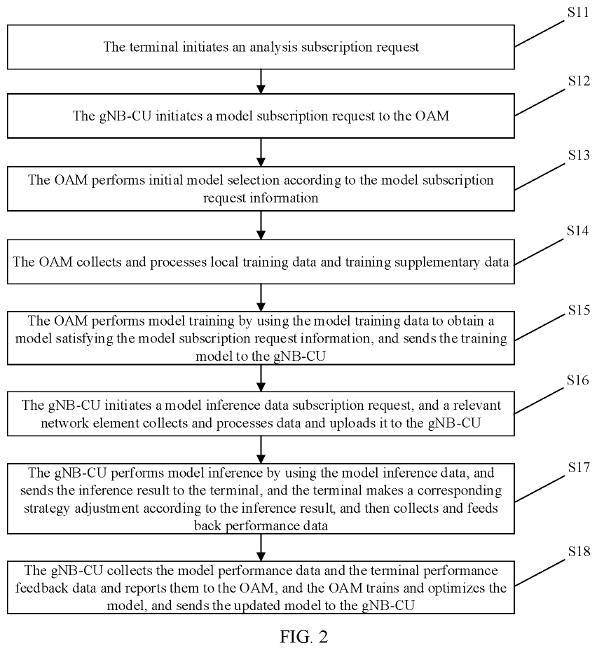

FIG. 2 is a flowchart of model training and model inference of a model data management method according to an embodiment. As shown in FIG. 2, the general model training and model inference process includes the following steps.

In step S11, the terminal initiates an analysis subscription request.

In the embodiment of the present disclosure, the terminal initiating the analysis subscription request includes the following steps: the terminal sending the analysis subscription request to the currently accessed gNB-DU, the analysis subscription request including an access location, a UE identity and an analysis request type, and the gNB-DU currently accessed by the terminal sending the analysis subscription request to the gNB-CU.

In an embodiment, the terminal accesses gNB-DU1, and gNB-DU1 and gNB-DU2 access gNB-CU1. The UE identity is 5G Globally Unique Temporary UE Identity (GUTI), and the analysis request type is represented by an analysis ID, such as analysis ID 1: location prediction analysis service, analysis ID 2: load prediction analysis service. The access location mainly includes information of the gNB-CU and the gNB-DU currently accessed by the terminal.

In step S12, the gNB-CU initiates a model subscription request to the OAM, the model subscription request including its own AI processing capability information and the analysis subscription request information of the terminal.

In the embodiment of the present disclosure, the AI processing capability information includes a computing speed and a current surplus computing power of the base station server.

In step S13, the OAM performs initial model selection according to the model subscription request.

In step S14, the OAM collects and processes local training data and training supplementary data.

In the embodiment of the present disclosure, the OAM collecting local training data and training supplementary data includes the following steps: the OAM initiating a training supplementary data subscription request to the gNB-CU, the gNB-CU initiating a training supplementary data subscription request to the gNB-DU, the gNB-DU collecting the training data and sending the training supplementary data to the gNB-CU, the gNB-CU collecting and processing the local training data and the received training data and uploading them to the OAM, and the OAM collecting and processing the local training data and the training supplementary data as model training data.

In step S15, the OAM performs model training by using the model training data to obtain a model satisfying the model subscription request information, and sends the training model to the gNB-CU.

In step S16, the gNB-CU initiates a model inference data subscription request, and a relevant network element collects and processes data and uploads it to the gNB-CU.

In the embodiment of the present disclosure, the gNB-CU initiating a model inference data subscription request and the relevant network element collecting data and uploading it to the gNB-CU includes the following steps: the gNB-CU initiating a model inference data subscription request to the gNB-DU currently accessed by the terminal (alternatively, other gNB-DU accessing the gNB-CU), and the gNB-DU currently accessed by the terminal(alternatively, other gNB-DU accessing the gNB-CU) collecting model inference data and uploading it to the gNB-CU.

In step S17: the gNB-CU performs model inference by using the model inference data, and sends the inference result to the terminal, and the terminal makes a corresponding strategy adjustment according to the inference result, and then collects and feeds back performance data.

In the embodiment of the present disclosure, the gNB-CU performing model inference by using the model inference data and sending the inference result to the terminal, and the terminal performing the corresponding strategy adjustment according to the inference result, includes the following steps: the gNB-CU performing model inference by using the model inference data, and sending the inference result to the gNB-DU accessed by the terminal, the gNB-DU sending the received inference result to the terminal, and the terminal making a corresponding strategy adjustment according to the inference result.

In step S18, the gNB-CU collects the model performance data and the terminal performance feedback data and reports them to the OAM, and the OAM performs training optimization on the model, and sends the updated model to the gNB-CU.

In the embodiment of the present disclosure, the gNB-CU collecting model performance data and terminal performance feedback data and reporting them to the OAM, and the OAM training and optimizing the model and sending the updated model to the gNB-CU, include the following steps: the gNB-CU comparing the inference result with the real data to obtain the model performance data, the terminal sending the performance feedback data to the gNB-DU, the gNB-DU sending it to the gNB-CU, the gNB-CU processing the model performance data and the terminal performance feedback data, and sending it to the OAM, the OAM performing training optimization on the model based on the model performance data and the performance feedback data, and sending the updated model parameter to the gNB-CU.

The model performance data is the model accuracy, and the performance feedback data is the quantification of the performance improvement brought by the AI analysis service. For example, after the terminal subscribes to a certain analysis and executes a corresponding strategy adjustment based on the analysis result, it can save power; for example, it can save power up to 5%.

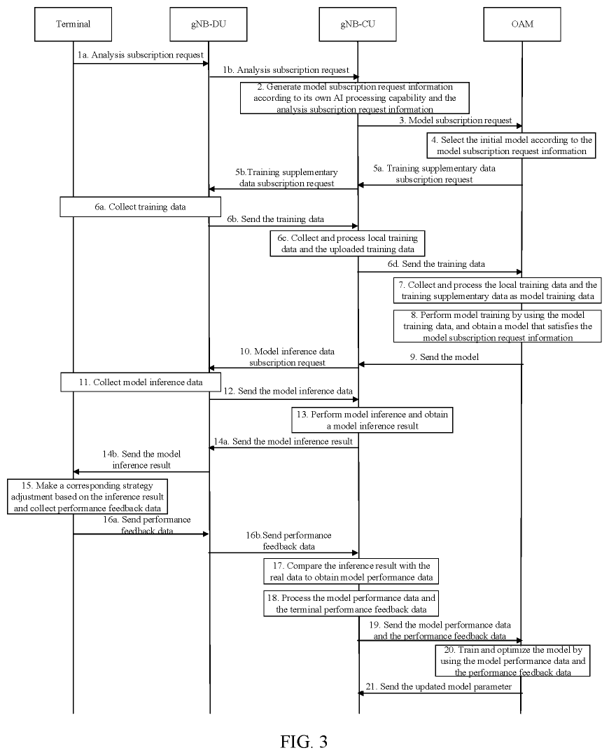

FIG. 3 is a schematic diagram of a protocol and interface of a mobility management method of a model data management method according to an embodiment. As shown in FIG. 3, it mainly involves the terminal, the gNB-DU accessed by the terminal, the gNB-CU accessed by the terminal, and the OAM provided by the embodiment of the present disclosure. The details are as follows.

1a. The terminal sends an analysis subscription request signaling to the gNB-DU, where the content indicated by the signaling is to initiate an analysis subscription request to the gNB-DU. 1b. The gNB-DU sends the analysis subscription request signaling to the gNB-CU, where the content indicated by the signaling is to initiate the analysis subscription request to the gNB-CU. 2. The gNB-CU generates model subscription request information according to its own AI processing capability and the analysis subscription request information. 3. The gNB-CU sends the model subscription request signaling to the OAM, where the content indicated by the signaling is to initiate a model subscription request to the OAM. 4. The OAM performs an initial model selection according to the model subscription request information to select a model to be trained that meets the analysis subscription request. 5a. The OAM sends the training supplementary data subscription request signaling to the gNB-CU, where the content indicated by the signaling is to initiate the training supplementary data subscription request to the gNB-CU. 5b. The gNB-CU sends the training supplementary data subscription request signaling to the gNB-DU, where the content indicated by the signaling is to initiate the training supplementary data subscription request to the gNB-DU. 6a. The gNB-DU collects training data. 6b. The gNB-DU sends the training data to the gNB-CU. 6c. The gNB-CU collects and processes local training data and the training data uploaded by the gNB-DU. 6d. The gNB-CU sends the processed training data to the OAM. 7. The OAM collects and processes the local training data and the uploaded training supplementary data as model training data. 8. The OAM performs model training by using the model training data, and obtains a model that satisfies the model subscription request information. 9. The OAM sends the model to the gNB-CU. 10. The gNB-CU sends the model inference data subscription request signaling to the gNB-DU, where the content indicated by the signaling is to initiate the model inference data subscription request to the gNB-DU. 11. The gNB-DU collects model inference data. 12. The gNB-DU sends the model inference data to the gNB-CU. 13. The gNB-CU performs model inference by using the model inference data and obtains a model inference result. 14a. The gNB-CU sends the model inference result to the gNB-DU. 14b. The gNB-DU sends the model inference result to the terminal. 15. The terminal makes a corresponding strategy adjustment based on the inference result and collects performance feedback data. 16a. The terminal sends the performance feedback data to the gNB-DU. 16b. The gNB-DU sends the performance feedback data to the gNB-CU. 17. The gNB-CU compares the inference result with the real data to obtain model performance data. 18. The gNB-CU processes the model performance data and the terminal performance feedback data. 19. The gNB-CU sends the model performance data and the terminal performance feedback data to the OAM. 20. The OAM performs training optimization on the model by using the model performance data and the performance feedback data. 21. The OAM sends the updated model parameter to the gNB-CU.

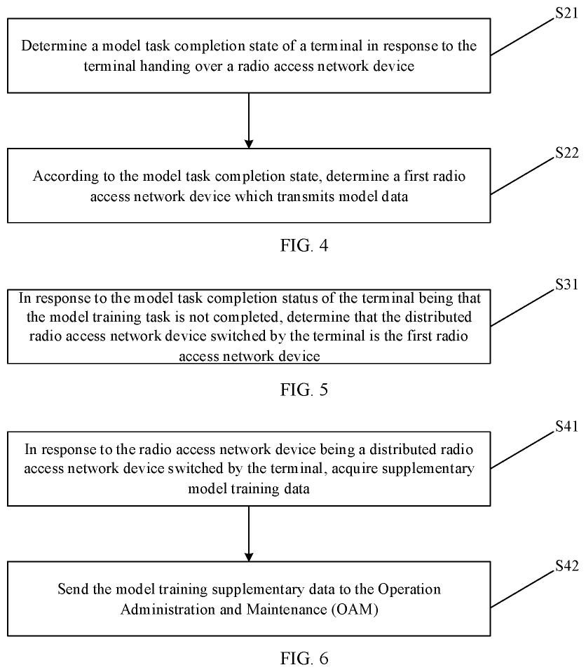

FIG. 4 is a flowchart showing a model data management method according to an embodiment. As shown in FIG. 4, the model data management method is applied in a radio access network device, including the following steps.

In step S21, in response to the terminal handing over a radio access network device, a model task completion status of the terminal is determined.

In the embodiment of the present disclosure, as mentioned above, in the process of training and inferring the model requested by the terminal, if the terminal moves and hands over the accessed wireless access device, the terminal re-initiates the analysis subscription request of the terminal to the distributed wireless access network device after handover. The distributed radio access network device reports the analysis subscription request of the terminal to the control radio access network device accessed by the terminal. The control radio access network device updates the analysis subscription request according to the analysis subscription request of the terminal, and determines the current model task completion status of the terminal. According to the model task completion status of the terminal, the first radio access network device for transmitting the model data is determined.

The model data may be model training data, model training supplementary data, model inference data, and other data related to the terminal model.

In step S22, according to the model task completion status, a first radio access network device for transmitting the model data is determined.

In the embodiment of the present disclosure, the model task completion status includes that the model training task is not completed and the model inference task is not completed. The radio access network device determines the first radio access network device for transmitting the model data after the terminal hands over to access the radio access network device.

Through the model data management method provided by the embodiments of the present disclosure, the radio access network device currently transmitting the training model data or the inference model data can be determined according to the model task completion status, which solves the problem that the wireless network AI cannot perform model training or the training result cannot be effectively delivered in the scenario of high-speed movement of the terminal, and solves the problem of loss of inference results caused by the handover of the terminal, thereby ensuring the efficiency and stability of wireless network AI services.

In some embodiments of the present disclosure, handing over the radio access network device by the terminal may be handing over the distributed radio access network device without handing over the control radio access network device, or handing over the distributed radio access network device and handing over the control access network device. It should be noted that the communication range of the control radio access network device may cover the communication ranges of a plurality of distributed radio access network devices.

If the terminal hands over the distributed radio access network device but does not hand over the control radio access network device, then determining the first radio access network device for transmitting the model data according to the model task completion status can adopt the following examples. The following embodiments will be described with reference to the accompanying drawings.

In an example, FIG. 5 is a flowchart showing a model data management method according to an embodiment. As shown in FIG. 5, the model data management method is applied in a radio access network device, including the following steps.

In step S31, in response to the model task completion status of the terminal being that the model training task is not completed, it is determined that the distributed radio access network device to which the terminal hands over is the first radio access network device.

In the embodiment of the present disclosure, in the case that the terminal hands over the distributed radio access network device and does not hand over the control radio access network device, if the model task completion status of the terminal is that the model training task is not completed, the terminal re-initiates an analysis subscription request of the terminal to the distributed wireless access network device after handover. This distributed radio access network device reports the analysis subscription request of the terminal to the control radio access network device accessed by the terminal. The control radio access network device updates the analysis subscription request according to the analysis subscription request of the terminal, and determines the current model task completion status of the terminal. It resends the model subscription request to the OAM. The model subscription request includes the AI processing capability information of the control radio access network device itself and the analysis subscription request of the terminal.

The OAM updates the analysis subscription request of the terminal according to the information reported by the gNB-CU. The OAM re-initiates a model training supplementary data subscription request, and determines that the distributed radio access network device to which the terminal hands over provides the OAM with the model training supplementary data. That is, it is determined that the distributed radio access network device to which the terminal hands over is the first radio access network device.

FIG. 6 is a flowchart showing a model data management method according to an embodiment. As shown in FIG. 6, the model data management method is applied in a radio access network device, including the following steps.

In step S41, in response to the radio access network device being the distributed radio access network device to which the terminal hands over, supplementary model training data is acquired.

In step S42, the model training supplementary data is sent to the Operation Administration and Maintenance (OAM).

The model training supplementary data is used for the OAM to continue training the model of the terminal.

In the embodiment of the present disclosure, the OAM initiates a model training supplementary data subscription request to the control radio access network device. The control radio access network device initiates a model training supplementary data subscription request to the distributed radio access network device newly accessed by the terminal. The distributed radio access network device newly accessed by the terminal collects terminal training data, and sends the terminal training data to the control radio access network device. The control radio access network device collects and processes the local training data of the control radio access network device, combines the local training data and the terminal training data, determines the model training supplementary data, and uploads the model training supplementary data to the OAM. The OAM collects and processes local training data of the OAM, and uses the local training data of the OAM and the model training supplementary data as the model training data. The OAM continues the model training by using the model training data, obtains a model that meets the model subscription request, and sends it to the control radio access network device.

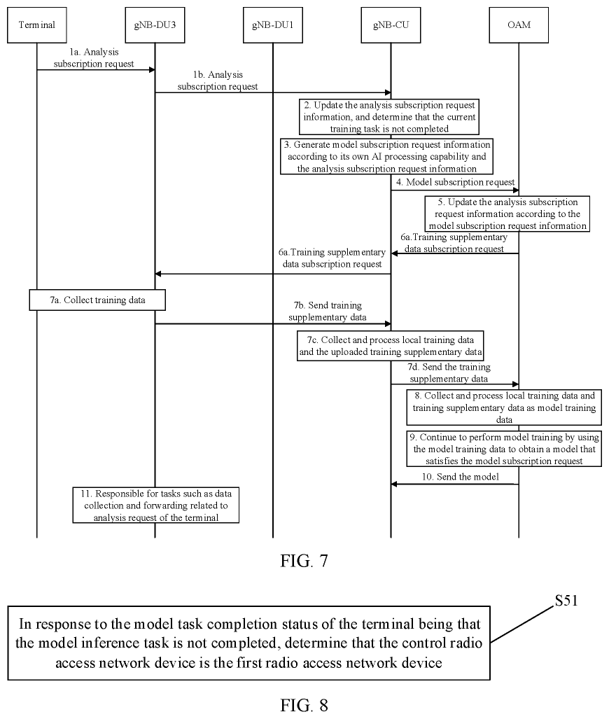

FIG. 7 is a schematic diagram of a protocol and interface of a terminal handing over under the same gNB-CU when a training task is not completed in a model data management method according to an embodiment. As shown in FIG. 7, it mainly involves the terminal, the source gNB-DU (gNB-DU1) of the terminal, the gNB-DU (gNB-DU3) newly accessed by the terminal, the gNB-CU accessed by the terminal, and the OAM provided by the embodiment of the present disclosure. The details are as follows.

1a. The terminal sends an analysis subscription request signaling to gNB-DU3, where the content indicated by the signaling is to initiate an analysis subscription request to the gNB-DU3. 1b. The gNB-DU3 sends the analysis subscription request signaling to the gNB-CU, where the content indicated by the signaling is to initiate the analysis subscription request to the gNB-CU. 2. The gNB-CU updates the analysis subscription request information, and determines that the current training task is not completed. 3. The gNB-CU generates model subscription request information according to its own AI processing capability and the analysis subscription request information. 4. The gNB-CU sends the model subscription request signaling to the OAM, where the content indicated by the signaling is to initiate a model subscription request to the OAM. 5. The OAM updates the analysis subscription request information according to the model subscription request information. 6a. The OAM sends the training supplementary data subscription request signaling to the gNB-CU, where the content indicated by the signaling is to initiate the training supplementary data subscription request to the gNB-CU. 6b. The gNB-CU sends the training supplementary data subscription request signaling to the gNB-DU3, where the content indicated by the signaling is to initiate the training supplementary data subscription request to the gNB-DU3. 7a. The gNB-DU3 collects training data. 7b. The gNB-DU3 sends training supplementary data to the gNB-CU. 7c. The gNB-CU collects and processes local training data and the training supplementary data uploaded by the gNB-DU3. 7d. The gNB-CU sends the processed training supplementary data to the OAM. 8. The OAM collects and processes local training data and the training supplementary data as model training data. 9. The OAM performs training by using the model training data to obtain a model that meets the model subscription request information. 10. The OAM sends the model to the gNB-CU. 11. The gNB-DU3 is responsible for tasks such as data collection and forwarding related to the analysis request of the terminal.

In another example, FIG. 8 is a flowchart showing a model data management method according to an embodiment. As shown in FIG. 8, the model data management method is applied in a radio access network device, including the following steps.

In step S51, in response to the model task completion status of the terminal being that the model inference task is not completed, it is determined that the control radio access network device is the first radio access network device.

In the embodiment of the present disclosure, when the terminal hands over the distributed radio access network device instead of handing over the control radio access network device, if the model task completion status of the terminal is that the model inference task is not completed, the control radio access network device sends an analysis subscription update request to the OAM to update the analysis subscription request of the terminal. The OAM updates the analysis subscription request based on the reported information. The control radio access network device continues to complete the inference task, and obtains model inference result data, and the control radio access network device sends the model inference result data to the terminal. That is, the control radio access network device is the first radio access network device, and it is determined that the terminal makes a corresponding decision-making adjustment based on the inference result data.

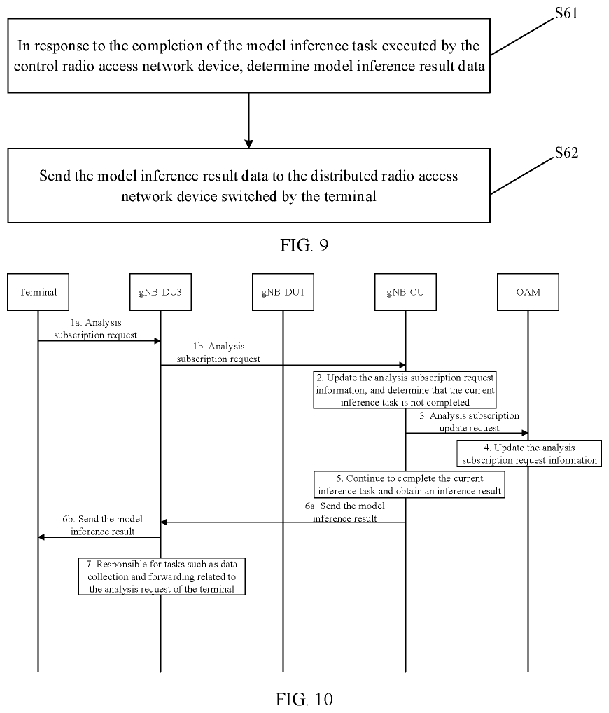

FIG. 9 is a flowchart showing a model data management method according to an embodiment. As shown in FIG. 9, the model data management method is applied in a radio access network device, and includes the following steps.

In step S61, in response to a completion of the model inference task executed by the control radio access network device, model inference result data is determined.

In step S62, the model inference result data is sent to the distributed radio access network device to which the terminal hands over.

In the embodiment of the present disclosure, after the control radio access network device continues to complete the inference task and obtains the model inference result data, the control radio access network device sends the model inference result data to the distributed radio access network device newly accessed by the terminal based on the terminal access location in the updated analysis subscription request. The distributed radio access network device newly accessed by the terminal forwards the model inference result data to the terminal, and the terminal makes a corresponding strategy adjustment according to the model inference result data. After the handover of the terminal is completed, the distributed radio access network device newly accessed by the terminal is responsible for tasks such as relevant data collection and forwarding.

FIG. 10 is a schematic diagram of a protocol and interface of a terminal handing over under the same gNB-CU when an inference task is not completed in a model data management method according to an embodiment. As shown in FIG. 10, it mainly involves the terminal, the source gNB-DU (gNB-DU1) of the terminal, the gNB-DU newly accessed by the terminal (gNB-DU3), the gNB-CU accessed by the terminal, and the OAM provided by the embodiment of the present disclosure. The details are as follows.

1a. The terminal sends an analysis subscription request signaling to the gNB-DU3, where the content indicated by the signaling is to initiate an analysis subscription request to the gNB-DU3. 1b. The gNB-DU3 sends the analysis subscription request signaling to the gNB-CU, where the content indicated by the signaling is to initiate the analysis subscription request to the gNB-CU. 2. The gNB-CU updates the analysis subscription request information of the terminal, and determines that the current inference task is not completed. 3. The gNB-CU sends the analysis subscription update request signaling to the OAM, where the content indicated by the signaling is to initiate the analysis subscription update request signaling to the OAM. 4. The OAM updates the analysis subscription request information of the terminal. 5. The gNB-CU continues to complete the model inference task and obtains the inference result. 6a. The gNB-CU sends the model inference result to the gNB-DU3. 6b. The gNB-DU3 sends the model inference result to the terminal. 7. The gNB-DU3 is responsible for tasks such as data collection and forwarding related to the analysis request of the terminal.

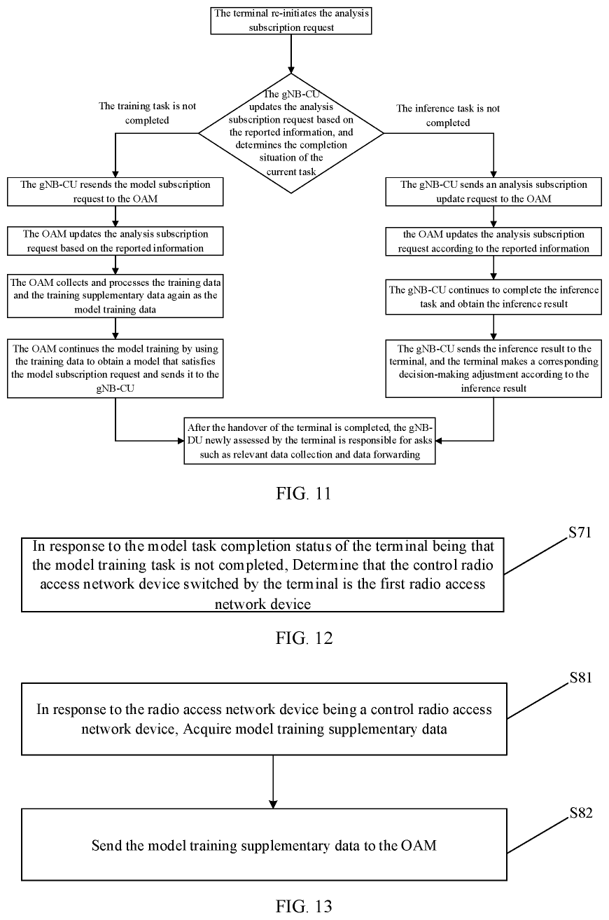

In some embodiments of the present disclosure, FIG. 11 is a flowchart of AI task delivery when a terminal hands over under the same gNB-CU in a model data management method according to an embodiment. As shown in FIG. 11, the terminal re-initiates the analysis subscription request, and the gNB-CU updates the analysis subscription request based on the reported information, and determines the current task completion situation. If the training task is not completed, the gNB-CU resends the model subscription request (the subscription request includes its own AI processing capability information and the analysis subscription request of the terminal) to the OAM, the OAM updates the analysis subscription request based on the reported information, the OAM collects and processes the training data and the training supplementary data again as the model training data, and the OAM continues the model training by using the training data to obtain a model that satisfies the model subscription request and sends it to the gNB-CU. After the handover of the terminal is completed, the gNB-DU newly assessed by the terminal is responsible for tasks such as relevant data collection and data forwarding. If the inference task is not completed, the gNB-CU sends an analysis subscription update request to the OAM, the OAM updates the analysis subscription request according to the reported information, the gNB-CU continues to complete the inference task and obtains the inference result, the gNB-CU sends the inference result to the terminal, and the terminal makes a corresponding decision-making adjustment according to the inference result. After the handover of the terminal is completed, the gNB-DU newly accessed by the terminal is responsible for relevant data collection and data forwarding tasks. In the embodiments of the present disclosure, the model training supplementary data may also be called training supplementary data, and the model inference result data may also be called inference result.

In particular, in some embodiments of the present disclosure, re-initiating the analysis subscription request by the terminal may include the following steps: the terminal initiating an analysis subscription request to a newly accessed gNB-DU, and the gNB-DU newly accessed by the terminal reporting the analysis subscription request to the gNB-CU.

In particular, in some embodiments of the present disclosure, the OAM re-collecting and processing the training data and the training supplementary data as model training data may include the following steps: the OAM initiating a training supplementary data subscription request to the gNB-CU, the gNB-CU initiating a training supplementary data subscription request to the gNB-DU newly accessed by the terminal, the gNB-DU newly accessed by the terminal collecting the training data and sending the training supplementary data to the gNB-CU, the gNB-CU collecting and processing local training data and the received training data and uploading them to the OAM, and the OAM collecting and processing the local training data and the training supplementary data as the model training data.

In particular, in some embodiments of the present disclosure, the gNB-CU sending the inference result to the terminal, and the terminal making a corresponding decision-making adjustment based on the inference result may include the following steps: the gNB-CU sending the inference result to the gNB-DU newly accessed by the terminal based on the terminal access location in the updated analysis subscription request, the gNB-DU newly accessed by the terminal forwarding the inference result to the terminal, and the terminal making a corresponding strategy adjustment according to the inference result.

In some embodiments of the present disclosure, determining the first radio access network device that transmits the model data according to the model task completion status if the terminal hands over the distributed radio access network device and hands over the control radio access network device may adopt the following examples. The following embodiments will be described with reference to the accompanying drawings.

In the embodiment of the present disclosure, in the case that the terminal hands over the distributed radio access network device and hands over the control radio access network device, the terminal re-initiates an analysis subscription request to the newly accessed distributed radio access network device, and the newly accessed distributed radio access network device sends the analysis subscription request to the control radio access network device newly accessed by the terminal. The control radio access network device newly accessed by the terminal sends a model subscription request to the OAM, where the subscription request includes its own AI processing capability information and an analysis subscription request. The OAM updates the analysis subscription request according to the model subscription request, and initiates an analysis subscription update request to the source control radio access network device. The source control radio access network device updates the analysis subscription request, and determines the completion situation of the current task.

In an example, FIG. 12 is a flowchart showing a model data management method according to an embodiment. As shown in FIG. 12, the model data management method is applied in a radio access network device, including the following steps.

In step S71, in response to the model task completion status of the terminal being that the model training task is not completed, it is determined that the control radio access network device to which the terminal hands over is the first radio access network device.

In the embodiment of the present disclosure, in the case that the terminal hands over the distributed radio access network device and hands over the control radio access network device, if the current model task completion status of the terminal is that the model training task is not completed, the source control radio access network device no longer sends the model training supplementary data to the OAM. In other words, the source control radio access network device no longer sends model training supplementary data to the OAM and is no longer responsible for the analysis subscription request of the terminal. That is, the control radio access network device to which the terminal hands over is the first radio access network device.

FIG. 13 is a flowchart showing a model data management method according to an embodiment. As shown in FIG. 13, the model data management method is applied in a radio access network device, including the following steps.

In step S81, in response to the radio access network device being a control radio access network device, model training supplementary data is acquired.

In step S82, the model training supplementary data is sent to the OAM.

The model training supplementary data is used for the OAM to continue training the model of the terminal.

In the embodiment of the present disclosure, the OAM initiates a model training supplementary data subscription request to the control radio access network device newly accessed by the terminal, and the control radio access network device newly accessed by the terminal sends a model training supplementary data subscription request to the distributed radio access network newly accessed by the terminal. The distributed radio access network device newly accessed by the terminal collects training data and sends supplementary model training data to the control radio access network device newly accessed by the terminal. The control radio access network device newly accessed by the terminal collects and processes the local training data and the received training data and uploads them to the OAM.

The OAM continues the model training by using the local training data and the training supplementary data to obtain a model that meets the model subscription request, and sends it to the control radio access network device newly accessed by the terminal. After the handover of the terminal is completed, the distributed radio access network device newly accessed by the terminal and the control radio access network device newly accessed by the terminal are responsible for relevant data collection, forwarding, model inference, data feedback and other tasks.

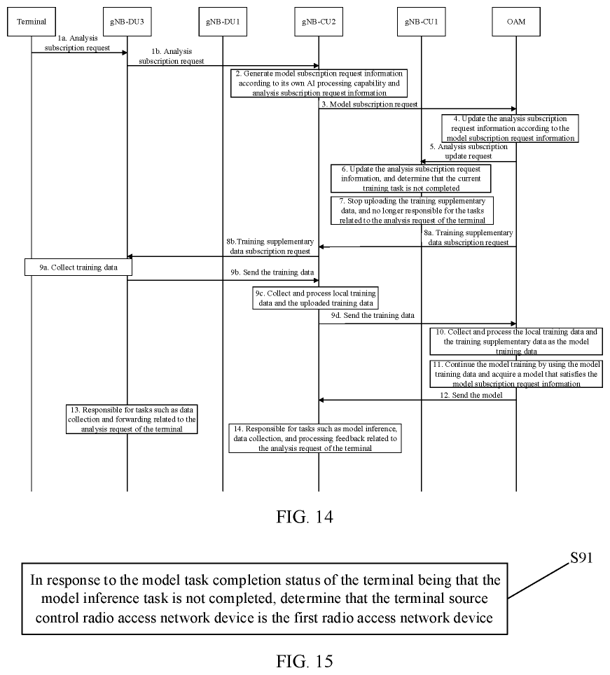

FIG. 14 is a schematic diagram of a protocol and interface of a terminal handing over between gNB-CUs when a training task is not completed in a model data management method according to an embodiment. As shown in FIG. 14, it mainly involves the terminal, the source gNB-DU (gNB-DU1) of the terminal, the gNB-DU newly accessed by the terminal (gNB-DU3), the source gNB-CU (gNB-DU1) of the terminal, the gNB-CU (gNB-CU2) newly accessed by the terminal, and the OAM provided by the embodiment of the present disclosure. The details are as follows.

1a. The terminal sends an analysis subscription request signaling to the gNB-DU3, where the content indicated by the signaling is to initiate an analysis subscription request to the gNB-DU3. 1b. The gNB-DU3 sends the analysis subscription request signaling to the gNB-CU2, where the content indicated by the signaling is to initiate the analysis subscription request to the gNB-CU2. 2. The gNB-CU2 generates model subscription request information according to its own AI processing capability and the analysis subscription request information. 3. The gNB-CU2 sends the model subscription request signaling to the OAM, where the content indicated by the signaling is to initiate the model subscription request to the OAM. 4. The OAM updates the analysis subscription request information according to the model subscription request information. 5. The OAM sends the analysis subscription update request signaling to the gNB-CUI, where the content indicated by the signaling is to initiate the analysis subscription update request to the gNB-CU1. 6. The gNB-CUI updates the analysis subscription request information, and determines that the current training task is not completed. 7. It stops uploading the training supplementary data, and it is no longer responsible for the tasks related to the analysis subscription request of the terminal. 8a. The OAM sends the training supplementary data subscription request signaling to the gNB-CU2, where the content indicated by the signaling is: initiating a training supplementary data subscription request to the gNB-CU2. 8b. The gNB-CU2 sends the training supplementary data subscription request signaling to the gNB-DU3, where the content indicated by the signaling is to initiate the training supplementary data subscription request to the gNB-DU3. 9a. The gNB-DU3 collects training data. 9b. The gNB-DU3 sends the training data to the gNB-CU2. 9c. The gNB-CU2 collects and processes local training data and the training data uploaded by the gNB-DU3. 9d. The gNB-CU2 sends the processed training data to the OAM. 10. The OAM collects and processes the local training data and the training supplementary data as the model training data. 11. The OAM continues model training by using the model training data and acquires a model that satisfies the model subscription request information. 12. The OAM sends the model to the gNB-CU2. 13. After the handover is completed, the gNB-DU3 is responsible for data collecting and forwarding related to the analysis request of the terminal. 14. After the handover is completed, the gNB-CU2 is responsible for tasks such as model inference, data collection, and processing feedback related to the analysis request of the terminal.

In another example, FIG. 15 is a flowchart showing a model data management method according to an embodiment. As shown in FIG. 15, the model data management method is applied in a radio access network device, including the following steps.

In step S91, in response to the model task completion status of the terminal being that the model inference task is not completed, it is determined that the terminal source control radio access network device is the first radio access network device.

In the embodiment of the present disclosure, when the terminal hands over the distributed radio access network device and hands over the control radio access network device, if the current model task completion status of the terminal is that the model inference task is not completed, it is determined that the source control radio access network device continues to complete the inference task. After obtaining the model inference result data, it sends the model inference result data to the control radio access network device newly accessed by the terminal according to the access location in the updated analysis request information, that is, the terminal source control radio access network device is determined as the first radio access network device.

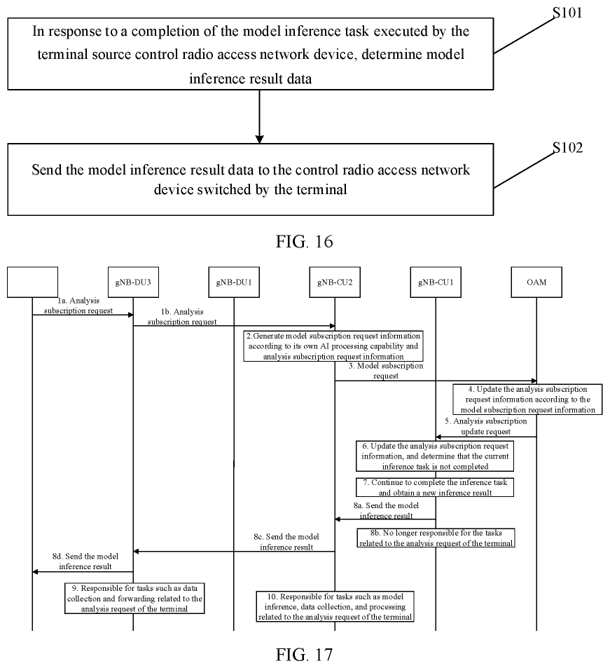

FIG. 16 is a flowchart showing a model data management method according to an embodiment. As shown in FIG. 16, the model data management method is applied in a radio access network device, and includes the following steps.

In step S101, in response to a completion of the model inference task executed by the terminal source control radio access network device, model inference result data is determined.

In step S102, the model inference result data is sent to the control radio access network device to which the terminal hands over.

In the embodiment of the present disclosure, the source control radio access network device continues to complete the inference task and obtains the inference result. The source control radio access network device sends the inference result to the control radio access network device newly accessed by the terminal according to the access location in the updated analysis subscription request, and then the source control radio access network device is no longer responsible for the tasks related to the analysis request of the terminal.

The control radio access network device newly accessed by the terminal sends the inference result to the terminal, and the terminal makes a corresponding strategy adjustment based on the inference result. The control radio access network device newly accessed by the terminal sends the inference result to the distributed radio access network device newly accessed by the terminal. The new distributed radio access network device sends the inference result to the terminal, and the terminal makes a corresponding strategy adjustment based on the inference result. After the handover of the terminal is completed, the distributed radio access network device newly accessed by the terminal and the control radio access network device newly accessed by the terminal are responsible for relevant data collection, forwarding, model inference, performance feedback and other tasks.

FIG. 17 is a schematic diagram of a protocol and interface of a terminal handing over between gNB-CUs when an inference task is not completed in a model data management method according to an embodiment. As shown in FIG. 17, it mainly involves the terminal, the source gNB-DU (gNB-DU1) of the terminal, the gNB-DU (gNB-DU3) newly accessed by the terminal, the source gNB-CU (gNB-DU1) of the terminal, the gNB-CU (gNB-CU2) newly accessed by the terminal, and the OAM provided by the embodiment of the present disclosure. The details are as follows.

1a. The terminal sends an analysis subscription request signaling to the gNB-DU3, where the content indicated by the signaling is to initiate an analysis subscription request to the gNB-DU3. 1b. The gNB-DU3 sends the analysis subscription request signaling to the gNB-CU2, where the content indicated by the signaling is to initiate the analysis subscription request to the gNB-CU2. 2. The gNB-CU2 generates model subscription request information according to its own AI processing capability and analysis subscription request information. 3. The gNB-CU2 sends the model subscription request signaling to the OAM, where the content indicated by the signaling is to initiate the model subscription request to the OAM. 4. The OAM updates the analysis subscription request information according to the model subscription request information. 5. The OAM sends the analysis subscription update request signaling to the gNB-CUI, where the content indicated by the signaling is to initiate the analysis subscription update request to the gNB-CU1. 6. The gNB-CUI updates the analysis subscription request information, and determines that the current inference task is not completed. 7. The gNB-CUI continues to complete the inference task and obtains a new inference result. 8a. The gNB-CUI sends the model inference result to the gNB-CU2. 8b. The gNB-CUI is no longer responsible for the tasks related to the analysis request of the terminal. 8c. The gNB-CU2 sends the model inference result to the gNB-DU3. 8d. The gNB-DU3 sends the model inference result to the terminal. 9. After the handover is completed, the gNB-DU3 is responsible for tasks such as data collection and forwarding related to the analysis request of the terminal. 10. After the handover is completed, the gNB-CU2 is responsible for tasks such as model inference, data collection, and processing related to the analysis request of the terminal.

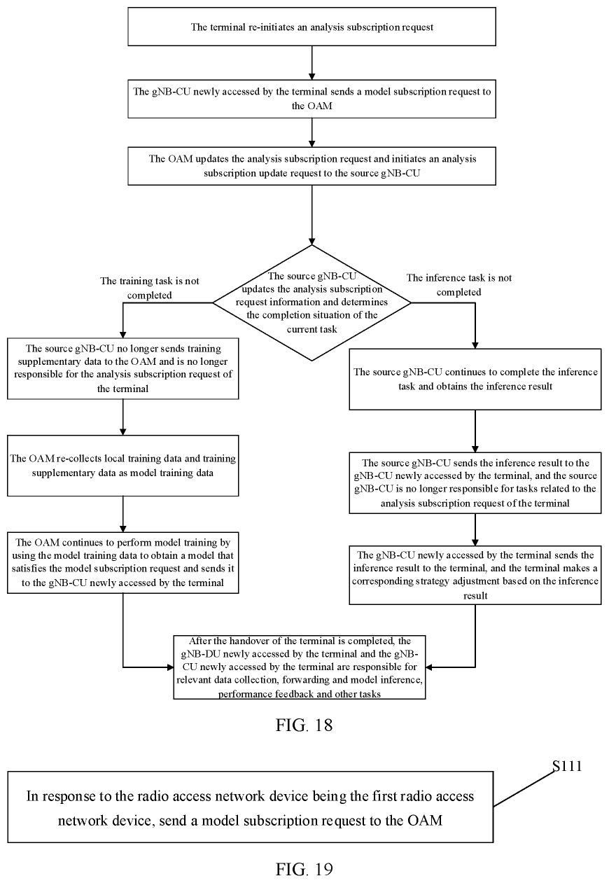

In some embodiments of the present disclosure, FIG. 18 is a flowchart of AI task delivery when a terminal hands over across gNB-CUs in a model data management method according to an embodiment. As shown in FIG. 18, the terminal re-initiates an analysis subscription request, the gNB-CU newly accessed by the terminal sends a model subscription request to the OAM, the OAM updates the analysis subscription request and initiates an analysis subscription update request to the source gNB-CU, and the source gNB-CU updates the analysis subscription request information and determines the completion situation of the current task. If the training task is not completed, the source gNB-CU no longer sends training supplementary data to the OAM and is no longer responsible for the analysis subscription request of the terminal. The OAM re-collects local training data and training supplementary data as model training data, and the OAM continues to perform model training by using the model training data to obtain a model that satisfies the model subscription request and sends it to the gNB-CU newly accessed by the terminal. After the handover of the terminal is completed, the gNB-DU newly accessed by the terminal and the gNB-CU newly accessed by the terminal are responsible for relevant data collection, forwarding and model inference, performance feedback and other tasks. If the inference task is not completed, the source gNB-CU continues to complete the inference task and obtains the inference result, the source gNB-CU sends the inference result to the gNB-CU newly accessed by the terminal, and the source gNB-CU is no longer responsible for tasks related to the analysis subscription request of the terminal, the gNB-CU newly accessed by the terminal sends the inference result to the terminal, and the terminal makes a corresponding strategy adjustment based on the inference result. After the handover of the terminal is completed, the gNB-DU newly accessed by the terminal and the gNB-CU newly accessed by the terminal are responsible for relevant data collection, forwarding, model inference, performance feedback and other tasks.

In particular, in some embodiments of the present disclosure, re-initiating the analysis subscription request by the terminal may include the following steps: the terminal initiating an analysis subscription request to a newly accessed gNB-DU, and the gNB-DU newly accessed by the terminal reporting the analysis subscription request to the gNB-CU.

In particular, in some embodiments of the present disclosure, the source gNB-CU no longer sends the training supplementary data to the OAM and is no longer responsible for the analysis subscription request of the terminal, which may include the following steps: the OAM initiating a training supplementary data subscription request to the gNB-CU newly accessed by the terminal, the gNB-CU newly accessed by the terminal initiating a training supplementary data subscription request to the gNB-DU newly accessed by the terminal, the gNB-DU newly accessed by the terminal collecting training data and sending the training supplementary data to the gNB-CU newly accessed by the terminal, the gNB-CU newly accessed by the terminal collecting and processing local training data and received training data and uploading them to the OAM, and the OAM collecting and processing local training data and training supplementary data as model training data.

In particular, in some embodiments of the present disclosure, the gNB-CU newly accessed by the terminal sending the inference result to the terminal, and the terminal making a corresponding strategy adjustment based on the inference result may include the following steps: the gNB-CU newly accessed by the terminal sending the inference result to the gNB-DU newly accessed by the terminal, the newly accessed gNB-DU sending the inference result to the terminal, and the terminal making a corresponding strategy adjustment based on the inference result.

FIG. 19 is a flowchart showing a model data management method according to an embodiment. As shown in FIG. 19, the model data management method is applied in a radio access network device, including the following steps.

In step S111, in response to the radio access network device being the first radio access network device, a model subscription request is sent to the OAM.

The model subscription request is used to request the OAM to update the information of the terminal.

In the embodiment of the present disclosure, if the terminal hands over the radio access network device, it resends the analysis subscription request of the terminal to the accessed radio access network device. The first radio access network device transmitting the model data resends the model subscription request to the OAM. If the first radio access network device is a distributed radio access network device, the distributed radio access network device resends the model subscription request to the OAM by the control radio access network device. If the first radio access network device is the control radio access network device, the control radio access network device resends the model subscription request to the OAM.

Based on the same/similar concept, the embodiment of the present disclosure also provides a model data management method.

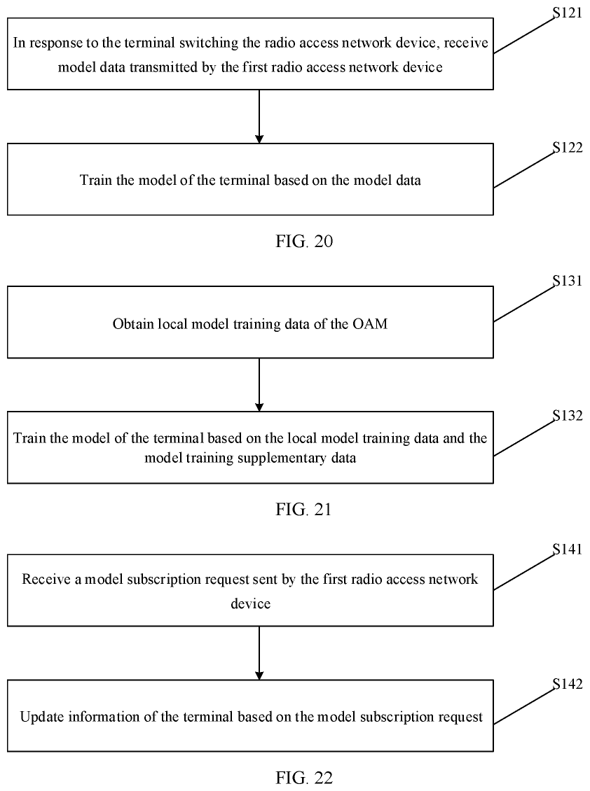

FIG. 20 is a flowchart showing a model data management method according to an embodiment. As shown in FIG. 20, the model data management method is applied in the OAM, including the following steps.

In step S121, in response to the terminal handing over the radio access network device, model data transmitted by the first radio access network device is received.

The first radio access network device is determined based on the model task completion state of the terminal.

In step S122, the model of the terminal is trained based on the model data.

In the embodiment of the present disclosure, if the OAM receives the model data transmitted by the first radio access network device, it determines that the terminal hands over the radio access network device, and the current model task completion status of the terminal is that the model training task is not completed. Based on the received model data, the OAM continues to train the model to obtain the training model of the terminal.

FIG. 21 is a flowchart showing a model data management method according to an embodiment. As shown in FIG. 21, the model data management method is applied in the OAM, including the following steps.

In step S131, local model training data of the OAM is acquired.

In step S132, the model of the terminal is trained based on the local model training data and the model training supplementary data.

In the embodiments of the present disclosure, the OAM collects and processes the local training data of the OAM, and uses the local training data of the OAM and the model training supplementary data as the model training data. The OAM continues model training by using the model training data to obtain a model that meets the model subscription request, and sends it to the control radio access network device.

FIG. 22 is a flowchart showing a model data management method according to an embodiment. As shown in FIG. 22, the model data management method is applied in the OAM, including the following steps.

In step S141, a model subscription request sent by the first radio access network device is received.

In step S142, information of the terminal is updated based on the model subscription request.

In the embodiment of the present disclosure, the OAM receives the model subscription request sent by the first radio access network device, and updates the information of the terminal, including the access location information after the terminal hands over the radio access network device.

Based on the same concept, the embodiment of the present disclosure also provides a model data management apparatus.

It can be understood that, in order to realize the above-mentioned functions, the model data management apparatus provided by the embodiments of the present disclosure includes corresponding hardware structures and/or software modules for performing various functions. Combining the units and algorithm steps of each example disclosed in the embodiments of the present disclosure, the embodiments of the present disclosure can be implemented in the form of hardware or a combination of hardware and computer software. Whether a certain function is executed by hardware or by computer software driving hardware depends on the specific application and design constraints of the technical solution. Those skilled in the art may use different methods to implement the described functions for each specific application, but such implementation should not be regarded as going beyond the scope of the technical solutions of the embodiments of the present disclosure.

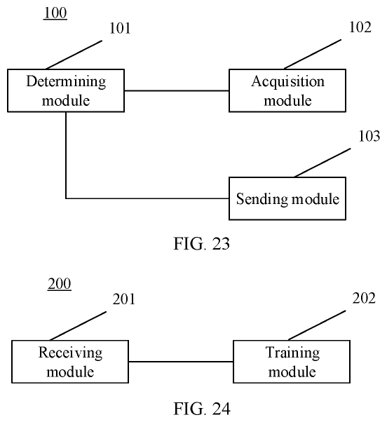

FIG. 23 is a block diagram of a model data management apparatus according to an embodiment. Referring to FIG. 23, the model data management apparatus 100 is applied to a radio access network device, and includes a determining module 101.

The determining module 101 is configured to determine a model task completion status of the terminal in response to the terminal handing over a radio access network device. According to the model task completion status, a first radio access network device for transmitting model data is determined.

In the embodiment of the present disclosure, the radio access network device to which the terminal hands over is a distributed radio access network device.

The determining module 101 is configured to determine that the distributed radio access network device to which the terminal hands over is the first radio access network device in response to the model task completion status of the terminal being that a model training task is not completed.

In an embodiment of the present disclosure, the model data includes model training supplementary data. The apparatus also includes: an acquisition module 102.

The acquisition module 102 is configured to acquire model training supplementary data in response to the radio access network device being the distributed radio access network device to which the terminal hands over. The model training supplementary data is sent to the Operation Administration and Maintenance (OAM), and the model training supplementary data is used for the OAM to continue training the model of the terminal.

In the embodiment of the present disclosure, the radio access network device to which the terminal hands over is a distributed radio access network device. The determining module 101 is configured to determine that the control radio access network device is the first radio access network device in response to the model task completion status of the terminal being that the model inference task is not completed.

In the embodiment of the present disclosure, the model data includes model inference result data. The determining module 101 is further configured to determine model inference result data in response to the completion of the control radio access network device executing the model inference task. The model inference result data is sent to the distributed radio access network device to which the terminal hands over.

In the embodiment of the present disclosure, the radio access network device to which the terminal hands over is the control radio access network device. The determining module 101 is configured to, in response to the model task completion status of the terminal being that the model training task is not completed, determine that the control radio access network device to which the terminal hands over is the first radio access network device.

In an embodiment of the present disclosure, the model data includes model training supplementary data. The acquisition module 102 is further configured to acquire the model training supplementary data in response to the radio access network device being the control radio access network device. The model training supplementary data is sent to the OAM, and the model training supplementary data is used for the OAM to continue training the model of the terminal.

In the embodiment of the present disclosure, the radio access network device to which the terminal hands over is the control radio access network device. The determining module 101 is configured to determine that a terminal source control radio access network device is the first radio access network device in response to the model task completion status of the terminal being that the model inference task is not completed.

In the embodiment of the present disclosure, the model data includes model inference result data. The determining module 101 is further configured to determine model inference result data in response to completion of the model inference task performed by the terminal source control radio access network device. The model inference result data is sent to the control radio access network device to which the terminal hands over.

In the embodiment of the present disclosure, the apparatus further includes: a sending module 103.

The sending module 103 is configured to send a model subscription request to the OAM in response to the radio access network device being the first radio access network device, where the model subscription request is used to request the OAM to update information of the terminal.

FIG. 24 is a block diagram of a model data management apparatus according to an embodiment. Referring to FIG. 24, the model data management apparatus 200 is applied to the OAM, and includes a receiving module 201 and a training module 202.

In the embodiment of the present disclosure, the receiving module 201 is configured to receive model data transmitted by the first radio access network device in response to the terminal handing over the radio access network device, and the first radio access network device is determined based on the model task completion status of the terminal. The training module 202 is configured to train the model of the terminal based on the model data.

In the embodiment of the present disclosure, the model data includes model training supplementary data. The training module 202 is configured to acquire local model training data of the OAM. Based on the local model training data and the model training supplementary data, the model of the terminal is trained.

In the embodiment of the present disclosure, the receiving module 201 is further configured to receive a model subscription request sent by the first radio access network device. The information of the terminal is updated based on the model subscription request.

Regarding the apparatuses in the above embodiments, the specific manners in which each module executes operations have been described in detail in the embodiments related to the method, and will not be described in detail here.

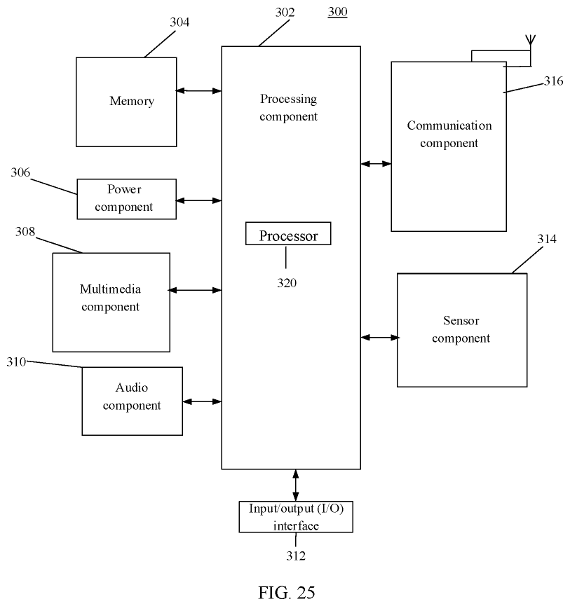

FIG. 25 is a block diagram of an apparatus 300 for managing model data according to an embodiment. For example, the apparatus 300 may be a mobile phone, a computer, a digital broadcast terminal, a messaging device, a gaming console, a tablet, a medical device, exercise equipment, a personal digital assistant, and the like.

Referring to FIG. 25, the apparatus 300 may include one or more of the following components: a processing component 302, a memory 304, a power component 306, a multimedia component 308, an audio component 310, an input/output (I/O) interface 312, a sensor component 314, and a communication component 316.

The processing component 302 typically controls overall operations of the apparatus 300, such as the operations associated with display, telephone calls, data communications, camera operations, and recording operations. The processing component 302 may include one or more processors 320 to execute instructions to perform all or part of the steps in the above described methods. Moreover, the processing component 302 may include one or more modules which facilitate the interaction between the processing component 302 and other components. For instance, the processing component 302 may include a multimedia module to facilitate the interaction between multimedia component 308 and the processing component 302.

The memory 304 is configured to store various types of data to support the operation of the apparatus 300. Examples of such data include instructions for any applications or methods operated on the apparatus 300, contact data, phonebook data, messages, pictures, video, etc. The memory 304 may be implemented by using any type of volatile or non-volatile memory devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 306 provides power to various components of the apparatus 300. The power component 306 may include a power management system, one or more power sources, and any other components associated with the generation, management, and distribution of power in the apparatus 300.

The multimedia component 308 includes a screen providing an output interface between the apparatus 300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 308 includes a front camera and/or a rear camera. The front camera and the rear camera may receive an external multimedia datum while the apparatus 300 is in an operation mode, such as a photographing mode or a video mode. Each of the front camera and rear camera may be a fixed optical lens system or have focus and optical zoom capability.

The audio component 310 is configured to output and/or input audio signals. For example, the audio component 310 includes a microphone (MIC) configured to receive an external audio signal when the apparatus 300 is in an operation mode, such as a call mode, a recording mode, and a voice recognition mode. The received audio signal may be further stored in the memory 304 or transmitted via the communication component 316. In some embodiments, the audio component 310 further includes a speaker to output audio signals.

The I/O interface 312 provides an interface between the processing component 302 and peripheral interface modules, such as a keyboard, a click wheel, buttons, and the like. The buttons may include, but are not limited to, a home button, a volume button, a starting button, and a locking button.

The sensor component 314 includes one or more sensors to provide status assessments of various aspects of the apparatus 300. For instance, the sensor component 314 may detect an open/closed state of the apparatus 300, relative positioning of components, e.g., the display and keypad, of the apparatus 300, a change in location of the apparatus 300 or a component of the apparatus 300, a presence or absence of user contact with the apparatus 300, an orientation or an acceleration/deceleration of the apparatus 300, and a change in temperature of the apparatus 300. The sensor assembly 314 may include a proximity sensor configured to detect the presence of nearby objects without any physical contact. The sensor component 314 may also include a light sensor, such as a CMOS or CCD image sensor, for use in imaging applications. In some embodiments, the sensor component 314 may also include an accelerometer sensor, a gyroscope sensor, a magnetic sensor, a pressure sensor, or a temperature sensor.

The communication component 316 is configured to facilitate communication, wired or wirelessly, between the apparatus 300 and other devices. The apparatus 300 can access a wireless network based on a communication standard, such as WiFi, 2G, or 3G, or a combination thereof. In one embodiment, the communication component 316 receives a broadcast signal or broadcast associated information from an external broadcast management system via a broadcast channel. In one embodiment, the communication component 316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the apparatus 300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In an embodiment, there is also provided a non-transitory computer-readable storage medium including instructions, such as the memory 304 including instructions, and the above instructions can be executed by the processor 320 of the apparatus 300 to implement the above described methods. For example, the non-transitory computer readable storage medium may be a ROM, a random access memory (RAM), a CD-ROM, a magnetic tape, a floppy disk, an optical data storage device, and the like.

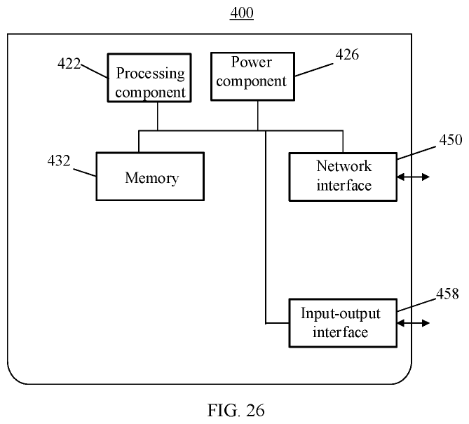

FIG. 26 is a block diagram of an apparatus 400 for managing model data according to an embodiment. For example, the apparatus 400 may be provided as a server. Referring to FIG. 26, the apparatus 400 includes a processing component 422, which further includes one or more processors, and a memory resource represented by a memory 432 for storing instructions executable by the processing component 422, such as application programs. The application programs stored in the memory 432 may include one or more modules each corresponding to a set of instructions. In addition, the processing component 422 is configured to execute the instructions to perform the above described methods.

The apparatus 400 may also include a power component 426 configured to perform power management of apparatus 400, a wired or wireless network interface 450 configured to connect the apparatus 400 to a network, and an input-output (I/O) interface 458. The apparatus 400 can operate based on an operating system stored in the memory 432, such as Windows Server™, Mac OS X™, Unix™, Linux™, FreeBSD™ or the like.

It can be further understood that “a plurality of” in the present disclosure refers to two or more, and other quantifiers are similar thereto. The expression “and/or” describes the association relationship of associated objects, indicating that there may be three types of relationships, for example, A and/or B may indicate: A exists alone, A and B exist simultaneously, and B exists alone. The character “/” generally indicates that the contextual objects are an “or” relationship. The singular forms “a/an,” “said,” and “the” are also intended to include the plural unless the context clearly dictates otherwise.

It can be further understood that the terms “first,” “second,” etc. are used to describe various information, but the information should not be limited to these terms. These terms are only used to distinguish information of the same type from one another, and do not imply a specific order or degree of importance. In fact, expressions such as “first” and “second” can be used interchangeably. For example, without departing from the scope of the present disclosure, first information may also be called second information, and similarly, second information may also be called first information.

It can be further understood that although operations are described in a specific order in the drawings in the embodiments of the present disclosure, it should not be understood as requiring that these operations be performed in the specific order shown or in a serial order or all operations shown be performed to obtain the desired result. In certain circumstances, multitasking and parallel processing may be advantageous.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A model data management method, applied to a radio access network device, wherein the method comprises:
in response to a terminal handing over the radio access network device, determining a model task completion status of the terminal;
determining a first radio access network device for transmitting model data according to the model task completion status.

2. The model data management method according to claim 1, wherein the radio access network device to which the terminal hands over is a distributed radio access network device; and
wherein determining the first radio access network device for transmitting the model data according to the model task completion status comprises:
in response to the model task completion status of the terminal being that a model training task is not completed, determining that the distributed radio access network device to which the terminal hands over is the first radio access network device.

3. The model data management method according to claim 2, wherein the model data comprises model training supplementary data; and
wherein the method further comprises:
in response to the radio access network device being the distributed radio access network device to which the terminal hands over, acquiring the model training supplementary data; and
sending the model training supplementary data to an Operation Administration and Maintenance (OAM), wherein the model training supplementary data is used for the OAM to continue training a model of the terminal.

4. The model data management method according to claim 1, wherein the radio access network device to which the terminal hands over is a distributed radio access network device; and
wherein determining the first radio access network device for transmitting the model data according to the model task completion status comprises:
in response to the model task completion status of the terminal being that a model inference task is not completed, determining that a control radio access network device is the first radio access network device.

5. The model data management method according to claim 4, wherein the model data comprises model inference result data; and
wherein the method further comprises:
in response to a completion of the model inference task performed by the control radio access network device, determining model inference result data; and
sending the model inference result data to the distributed radio access network device to which the terminal hands over.

6. The model data management method according to claim 1, wherein the radio access network device to which the terminal hands over is a control radio access network device; and
wherein determining the first radio access network device for transmitting the model data according to the model task completion status comprises:
in response to the model task completion status of the terminal being that a model training task is not completed, determining that the control radio access network device to which the terminal hands over is the first radio access network device.

7. The model data management method according to claim 6, wherein the model data comprises model training supplementary data; and
wherein the method further comprises:
in response to the radio access network device being the control radio access network device, acquiring the model training supplementary data; and
sending the model training supplementary data to an Operation Administration and Maintenance (OAM), wherein the model training supplementary data is used for the OAM to continue training a model of the terminal.

8. The model data management method according to claim 1, wherein the radio access network device to which the terminal hands over is a control radio access network device; and
wherein determining the first radio access network device for transmitting the model data according to the model task completion status comprises:
in response to the model task completion status of the terminal being that a model inference task is not completed, determining that a terminal source control radio access network device is the first radio access network device.

9. The model data management method according to claim 8, wherein the model data comprises model inference result data; and
wherein the method further comprises:
in response to a completion of the model inference task performed by the terminal source control radio access network device, determining the model inference result data; and
sending the model inference result data to the control radio access network device to which the terminal hands over.

10. The model data management method according to claim 1, wherein the method further comprises:
in response to the radio access network device being the first radio access network device, sending a model subscription request to an Operation Administration and Maintenance (OAM), wherein the model subscription request is used to request the OAM to update information of the terminal.

11. A model data management method, applied to an Operation Administration and Maintenance (OAM) entity, wherein the method comprises:
receiving model data transmitted by a first radio access network device in response to a terminal handing over a radio access network device, wherein the first radio access network device is determined based on a model task completion status of the terminal; and
training a model of the terminal based on the model data.

12. The model data management method according to claim 11, wherein the model data comprises model training supplementary data; and
wherein training the model requested by the terminal based on the model data comprises:
acquiring local model training data of the OAM; and
training the model of the terminal based on the local model training data and the model training supplementary data.

13. The model data management method according to claim 12, further comprising:
receiving a model subscription request sent by the first radio access network device; and
updating information of the terminal based on the model subscription request.

14. A model data management apparatus, applied to a radio access network device, wherein the apparatus comprises:
a processor, and
a memory for storing instructions executable by the processor;
wherein the processor is configured to: in response to a terminal handing over the radio access network device, determine a model task completion status of the terminal; and determine a first radio access network device for transmitting model data according to the model task completion status.

15. (canceled)

16. A model data management apparatus, comprising:
a processor and
a memory for storing instructions executable by the processor;
wherein the processor is configured to perform acts according to claim 11.

17. (canceled)

18. The model data management apparatus according to claim 14, wherein the radio access network device to which the terminal hands over is a distributed radio access network device; and
wherein the processor is further configured to:
in response to the model task completion status of the terminal being that a model training task is not completed, determine that the distributed radio access network device to which the terminal hands over is the first radio access network device.

19. The model data management apparatus according to claim 18, wherein the model data comprises model training supplementary data; and
wherein the processor is further configured to:
in response to the radio access network device being the distributed radio access network device to which the terminal hands over, acquire the model training supplementary data; and
send the model training supplementary data to an Operation Administration and Maintenance (OAM), wherein the model training supplementary data is used for the OAM to continue training a model of the terminal.

20. The model data management apparatus according to claim 14, wherein the radio access network device to which the terminal hands over is a distributed radio access network device; and
wherein the processor is further configured to:
in response to the model task completion status of the terminal being that a model inference task is not completed, determine that a control radio access network device is the first radio access network device.

21. The model data management apparatus according to claim 20, wherein the model data comprises model inference result data; and
wherein the processor is further configured to:
in response to a completion of the model inference task performed by the control radio access network device, determine the model inference result data; and
send the model inference result data to the distributed radio access network device to which the terminal hands over.

22. The model data management apparatus according to claim 14, wherein the radio access network device to which the terminal hands over is a control radio access network device; and
wherein the processor is further configured to:
in response to the model task completion status of the terminal being that a model training task is not completed, determine that the control radio access network device to which the terminal hands over is the first radio access network device.
